(19) United States
(12) Patent Application Publication
(10) Pub. No.: US 2013/0093895 A1
(43) Pub. Date: Apr. 18, 2013

(54) SYSTEM FOR COLLISION PREDICTION AND TRAFFIC VIOLATION DETECTION

(71) Applicants: Samuel David Palmer, Jerusalem (IL); Ofer Netanel Aharoni, Jerusalem (IL)

(72) Inventors: Samuel David Palmer, Jerusalem (IL); Ofer Netanel Aharoni, Jerusalem (IL)

(21) Appl. No.: 13/274,476

(22) Filed: Oct. 17, 2011

(51) Int. Cl. H04N 7/18

(52) U.S. Cl. 348/149; 348/E07.085

(57) ABSTRACT

The invention refers to a system for monitoring, analyzing and reporting incidences of traffic violations at a predetermined area in real-time, prospectively or retrospectively. Specifically, the invention refers to a system and method of monitoring, analyzing, predicting and reporting or warning the incidence of a past or imminent traffic violation by acquiring a moving object within a predetermined boundary, assigning a path to the moving object and based on a plurality of thresholds, determining the likelihood of a traffic violation type and occurrence.

### FIELD OF THE INVENTION

The invention relates to a system for monitoring, analyzing and reporting incidences of traffic violations at a predetermined area. Specifically, the invention relates to a system and method of monitoring, analyzing, predicting and reporting or warning the incidence of a past or imminent traffic violation by acquiring a moving object within a predetermined boundary, assigning a path to the moving object and based on a plurality of thresholds, determining the likelihood of a traffic violation type and occurrence.

### BACKGROUND

Camera-based traffic monitoring systems have become increasingly deployed by private companies, law enforcement agencies and municipalities to enforce traffic laws and modify unsafe driving behavior, such as speeding running red lights or stop signs, and making illegal turns. The most effective programs combine consistent use of traffic cameras supported by automated processing solutions that deliver rapid ticketing of traffic violators, However, many current traffic enforcement systems using photographic techniques have disadvantages that generally do not facilitate efficient automation and validation of the photographs required for effective use as legal evidence.

Digital-based red-light camera systems have come to replace traditional 35 mm analog-based cameras and photographic techniques to acquire the photographic evidence of traffic offenses. In the field of traffic enforcement technologies, capturing vehicle offense data involves a compromise between storage space requirements and image resolution.

However the majority of traffic accidents are not caused by Red Light and Speeding violations. Violations which cause far more accidents such as failure to yield Right of Way, failure to maintain safe distance at a given velocity or failure to obey a Stop Sign are not monitored or enforced automatically. Studies have shown, that automatic enforcement can reduce accident causing violations.

Moreover, currently installed systems are retroactive in nature, meaning they report the violation once they have occurred and for the most part, are unable to predict the violation type and likelihood in a prospective manner.

Accordingly, a need still exists for a system capable of monitoring a defined are for prospective traffic violations as well as retroactive analysis of a variety of violation associated with accidents and that is able of providing either a comprehensive report or a warning to an end user.

### SUMMARY OF THE INVENTION

The invention provides a method of detecting a traffic violation, the method comprising the steps of: obtaining a reference frame of a defined monitored area; defining a plurality of thresholds within the defined area; using a video source, acquiring one or more moving objects within the defined area; associating the acquired object with a previously acquired or a new trajectory; considering the plurality thresholds, detecting a violation wherein, if the acquired or new trajectory violates a predefined threshold a violation has occurred.

In an embodiment, the invention provides a method of detecting a predefined traffic violation: using a video source, obtaining a reference frame of a defined monitored area; defining parameters specific to the reference frame such as a plurality of regions within the monitored area; acquiring a plurality of moving objects within the defined area and assigning an acquired trajectory to each of the moving objects; determining whether a violation has occurred whereby if a trajectory moves through the defined regions in a predefined sequence a threshold violation has occurred.

In an embodiment, the invention provides a method of predicting a collision between two or more moving objects or between a moving object and still object, the method comprising the steps of: using a video source, obtaining a reference frame of a defined monitored area; defining parameters specific to the reference frame such as based on an object's speed and distance from a possible collision; acquiring a plurality of moving objects within the defined area and assigning an acquired trajectory to each of the moving objects; associating the acquired object with a previously acquired or a new trajectory in real time; analyzing the acquired or new trajectory of the moving objects, whereby if two or more trajectories intersect within a predetermined time, a threshold violation has occurred and a collision is likely to occur.

In an embodiment, the invention provides a method for analyzing a traffic violation associated with failure to give right of way within a predetermined area, the method comprising the steps of: using a video source, obtaining a reference frame of a defined monitored area; defining parameters specific to the reference frame such as a plurality of regions of which each region's precedence over any other region is defined; acquiring a plurality of moving objects within the defined area and assigning an acquired trajectory to each of the moving objects; associating the acquired object with a previously acquired or a new trajectory; analyzing the acquired or new trajectory of the moving objects, whereby based on the predetermined parameters if two or more trajectories converge within a predetermined time, and one of the moving objects shows a sudden change in trajectory, and based on region precedence it can be determined that the object which performed the sudden change has right of way, a threshold violation has occurred.

In another embodiment, the invention provides a system for monitoring, determining and reporting a traffic violation, the system comprising: a digital video source; an integral processor, the integral processor operably connected to the video source and capable of: acquiring at least one object from within a predetermined defined area obtained from the video source; assigning a trajectory to the acquired object; determining if a violation has occurred, wherein a predefined threshold has been violated; creating and saving analysis data; and a transmitter, capable of transmitting the analysis data to a remote user.

### BRIEF DESCRIPTION OF THE DRAWINGS

The invention will be more fully understood by reference to the following detailed description of the invention in conjunction with the drawings, of which:

FIG. 1 shows a flow diagram describing an embodiment of the methods described herein;

FIG. 2 shows a schematic of an embodiment illustrating the division of a monitored area into regions used for a detection of an illegal U-turn;

FIG. 3 shows a schematic of an embodiment illustrating the system analysis for detecting and analyzing a traffic violation associated with a failure to provide a right-of-way;

FIG. 4 shows a schematic illustration of a division of the monitored area to regions for the purpose of monitoring, detecting and predicting violations associated with speeding (A), crossing of a white line (B) and J-walking (C); and

FIG. 5 shows a schematic illustration of the use of the method and system in an embodiment for the prediction of an accident based on projected trajectory of two acquired moving objects.

### DETAILED DESCRIPTION

In one embodiment, the invention relates to systems for monitoring, analyzing and reporting incidences of traffic violations in real-time at a predetermined area. In another embodiment, the invention relates to a system and method of monitoring, analyzing, predicting and reporting or warning the incidence of a past or imminent traffic violation by acquiring a moving object within a predetermined boundary, assigning a path to the moving object and based on a plurality of thresholds, determining the likelihood of a traffic violation type and occurrence

In an embodiment, the methods and systems present a comprehensive violation detection solution and collision prediction solution for human-factor accidents causes. The system is capable of not only detecting and recording offenders, but also provides Real-Time alerts in case of a possible collision. This two pronged approach is far more effective at improving road safety, than the systems and methods currently in use in the art.

Turning now to FIG. 1 showing a schematic flow chart of an embodiment of the method for monitoring, detecting and/or predicting a traffic violation in an area. In FIG. 1, a video source is used to provide a feed from a predetermined area. The video source is a digital video camera in one embodiment, or a video file in another embodiment. In one embodiment, the term “video source” refers to an analog or digital source of video information; for example, an analog, digital, or satellite tuner, or software and/or hardware to generate a video data stream for a particular channel from incoming video data for a plurality of channels. In another embodiment, when using an analog signal, the signal is digitized, referring merely to the conversion or conditioning of a video signal from an analog form into a digital counterpart having a one-to-one correspondence with the analog signal, in the systems and methods described herein as an integral part of getting the video source by. Generally speaking, a video signal may be digitized by converting a voltage level of the video signal above a threshold level to a first high voltage level, and converting a voltage level of the video signal below a threshold level to a second low voltage level. In another embodiment, the term “video source” refers to a source signal containing audio data, video data, or any combination thereof. In one embodiment, the video source is a video file having a format of MPEG-1, MPEG-2, MPEG-4, Flash, QuickTime, Windows Media, AVI, 3GP, H.261, H.263, H.264, WMV, DVD/VCD, RM, RMVB, DivX, ASF, VOB and the like. A person of skill in the art would readily recognize that the methods and systems described herein intend to encompass video files obtained in real time using a digital camera or an analog video camera following digitizing of the analog data, as well as an after-the-fact ability to analyze a video file of the monitored area.

Returning to FIG. 1, In an embodiment Motion Detection can be done by acquiring a reference frame against which any additional frames are compared. The reference frame of the monitored area is substantially empty of any moving objects. Accordingly and in an embodiment, the step of obtaining a reference frame further comprises assigning a value to each pixel in the reference frame.

In one embodiment motion is detected by determining based on predetermined criteria that the values of a plurality of pixels in a frame (n₁) are different from a plurality of pixels' values at the same location in the reference frame, the plurality of pixels represents an object, or “Blob” in another embodiment. In one embodiment, the term “blob” refers to the minimal symmetric or asymmetric shape which based on the motion detection algorithm's decision contains pixel values that have been decided to be different from the pixels at the same position in the reference frame.

In certain embodiments of the methods and systems described herein, Pixels are associated with a particular blob based on distance from one another. Within the context of the solution, a blob acts in one embodiment as a container for momentary data related to the path to which the blob belongs. Data such as current speed and direction are stored “within” the blob. Such data are acquired by comparing a blob's location in the reference frame with the location of the previous blob in the same trajectory. Blobs are acquired using the Motion Detection module.

In one embodiment, comparing obtained frames with the reference frame using the step of tracking motion in the methods provided utilizing the system's motion tracking module, enables the assignment of paths and/or trajectories to any acquired moving object. In another embodiment, paths are defined as an objects (or blobs) progression over time, whereby progression is the increment in the blob's location in space over sequential frames. Any blob is assigned to a path using the Motion Tracking module in the systems provided herein. In one embodiment, the step of associating the acquired object with a previously acquired, or a new trajectory comprises the step of comparing the position progression of the plurality of symmetric or asymmetric pixels or blobs as a function of time and accordingly extrapolating a new position within the defined area, region, region boundary or their combination. The increment in the blob's location requires in one embodiment distance mapping of the pixels representing the blob between consecutive frames. Accordingly and in one embodiment, for detecting certain violations, it is imperative to be able to accurately measure real-world distances within a bitmap, namely to assign a distance per pixel and to accurately detect the resolution of the digitized bitmap. All distance measuring is done in one embodiment, using a distance-per-pixel mapping algorithm developed specifically for this purpose. In one embodiment, the step of obtaining a reference frame further comprises the step of calculating, obtaining or assigning a physical distance per pixel.

In certain embodiments, the step of detecting a violation in the methods and systems provided herein is done by determining whether a threshold has been violated. Depending on the embodiment, determining a threshold violation is comprised of the steps: defining a set of region boundaries within the defined area; determining the sequence under which, for any given trajectory region boundaries are crossed; comparing that sequence with a reference sequence wherein if the sequence under which the trajectory crosses region boundaries is the same as predefined reference sequence, the threshold has been violated. Additionally, a time variable can be assigned to regions such that if the trajectory enters or leaves a region within a specific time frame while it passes through the regions a threshold has been violated. Or, defining a time frame (t) and delta value (Δ) such that if for any two given trajectories, based on their current respective directions and speeds the trajectories will intersect within time t±Δ, a threshold has been violated. Or, defining a distance value (d), a deceleration value (m) and a set of precedence regions such that for any two trajectory intersection points, if prior to the intersection point it can be determined based on the precedence regions that trajectory x1 has precedence over the trajectory x2 and trajectory x1 decelerated over distance d an amount equal or larger than deceleration m a threshold has been violated. In some embodiments, once a determination has been made that a threshold has been violated, the system will send a notice to that effect to an end user, such as any vehicle involved or an appropriate end user.

In one embodiment, the methods and systems described herein define boundaries within the monitored reference frame. The step of defining region boundaries within the monitored area comprises in certain embodiments, assigning a marker to a region, the marker being a line, a crossing, a curb, a traffic sign, a junction, a stationary object or a combination thereof. In an embodiment region boundaries can be defined by defining a plurality of geometric shapes whose coordinates are defined by the pixel indices in the reference frame. In yet another embodiment, a Voroni diagram is constructed for the monitored area. Whereby, given a collection of geometric primitives such as a line, a crossing, a curb, a traffic sign, a junction, a stationary object or a combination thereof, it is a subdivision of space into cells (regions) such that all points in a cell are closer to one primitive than to any other. In one embodiment, the term “Voroni diagram” refers to a decomposition of a metric space determined by distances to a specified discrete set of objects in the space. In another embodiment, the discrete objects are a line, a crossing, a curb, a traffic sign, a junction, a stationary object or a combination thereof. In one embodiment, for a set of points S, the Voroni diagram for S is the partition of the plane which associates a region V(p) with each point p from S in such a way that all points in V(p) are closer to p than any other point from S. Application of the Voroni diagram are further described in the Figures herein.

In one embodiment, an image feature extracted from the reference frame used in the methods and systems described herein, is a region's boundaries or the ratio of the estimated boundary length (the boundary calculated using a fraction of the boundary pixels) to the actual boundary length; ratio of the boundary length to the area enclosed by the boundary; and the sum of the difference between the distance from the center of the region to the boundary and the average of the distances from the center to the two adjacent points in other embodiments of region boundaries used as the extracted image feature in the methods and systems described herein.

In one embodiment, based on predetermined criteria, a plurality of thresholds is determined within the defined area. The term “threshold” as used herein, refers to a rule or a set of rules which define a desirable sequence of events, the breach of which, under certain circumstances, will constitute a traffic violation. The predetermined criteria used to provide the threshold comprises in one embodiment the traffic violation or violations sought to be monitored, detected and for which an alarm is required. Threshold may change with the defined region or defined violation or changes in the reference frame.

In certain embodiments, a reference frame is updated every 1 to 15 minutes and its pixel values are integrated into the processing module of the systems described herein. In another embodiment, the reference frame is updated every 1 to 12 minutes, or in another embodiment, every 1 to 9 minutes, or in another embodiment, every 1 to 6 minutes, or in another embodiment, every 1 to 3 minutes, or in another embodiment, every 1 to 2 minutes, or in another embodiment, every 1 to 30 seconds, or in another embodiment, every 1 to 2 days, or in another embodiment, every 1 to 6 hours, or in another embodiment, every other time interval capable of providing an accurate reference frame of the are sought to be monitored.

In another embodiment, the methods provided herein are performed using the systems provided herein, wherein the system for monitoring, determining and reporting a traffic violation, comprise: a digital video source; an integral processor, the integral processor operably connected to the video source and capable of: acquiring at least one object within a predetermined defined area obtained from the video source; identifying motion of the acquired object assigning a trajectory to the acquired object; determining if the acquired trajectory violates a predefined threshold creating and saving analysis data; and a transmitter, capable of transmitting the analysis data to a remote user.

In certain embodiments of the systems and methods provided herein, the analysis data of the violation is saved in the memory module of the system or the methods provided, wherein the analysis data is saved on a computer-readable media. In another embodiment, the analysis data of the violation is transmitted to a remote user, such as a vehicle, a remote server, an internet-based storage server and wherein the remote user is capable of accessing the data using the internet.

In an embodiment, the systems described herein further comprise a memory module, a screen or their combination, operably connected to a computer. In another embodiment, the transmitter used in the systems described herein is a MIMO transmitter having a RF terminal, a WWAN terminal, a WLAN terminal or a combination thereof. In one embodiment, the transmitter is a single terminal transmitter such as a RF terminal, a WWAN terminal, a WLAN terminal and the like. In one embodiment, the analysis data obtained by the systems and methods described herein, is transmitted via internet to a moving vehicle acquired by the system in the form of a collision warning, wherein the collision is between the moving vehicle and another moving vehicle and/or stationary object. In another embodiment, the data transmitted is in a form of command to a moving vehicle identified by the system, the command capable of affecting the vehicle path or trajectory.

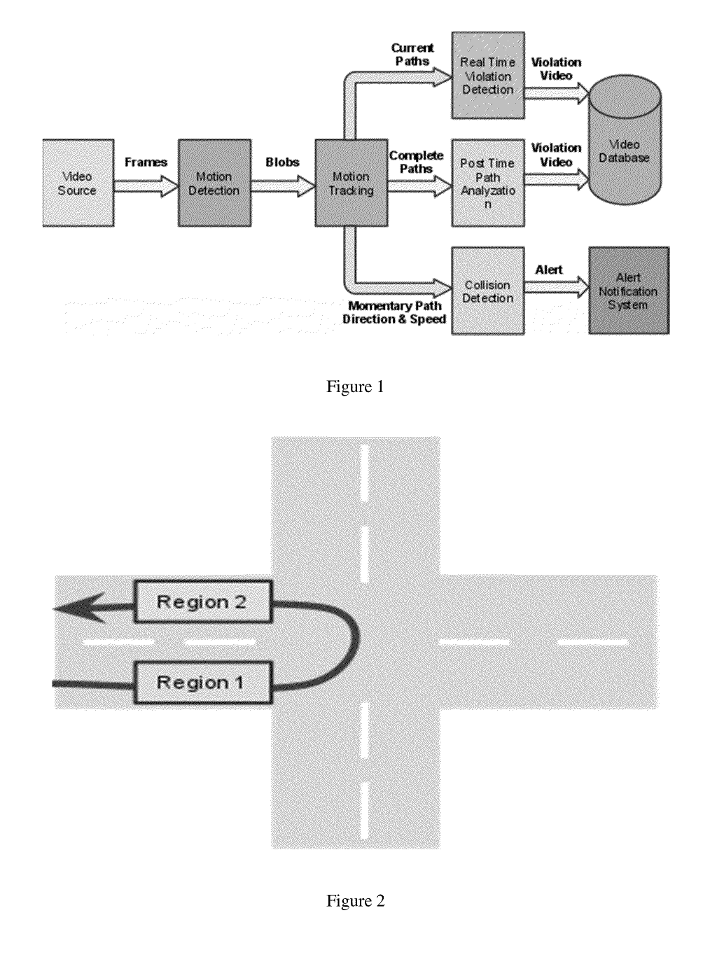

Turning now to FIG. 2; based on the motion detection and the motion tracking modules, the behavior of each moving objects' path is analyzed. The area which is to be monitored is separated into regions as described above.

In an Example, if an object passes through the regions in a specific sequence a violation has occurred. Multiple regions and sequences are defined. A vehicle's which performs an illegal U-Turn is sought to be identified, either in real time, prospectively or retroactively. As shown in FIG. 2, the vehicles that potentially perform the violation enter the frame from the left. Halfway through the frame there is an intersection. Region 1 is defined as the right side of the road (as the vehicle progresses from left to right) in the area prior to the intersection. Region 2 is the area on the left side of the road (as the vehicle progresses from left to right). If the vehicle path passes through Region 1 and then Region 2, a U-Turn has been performed.

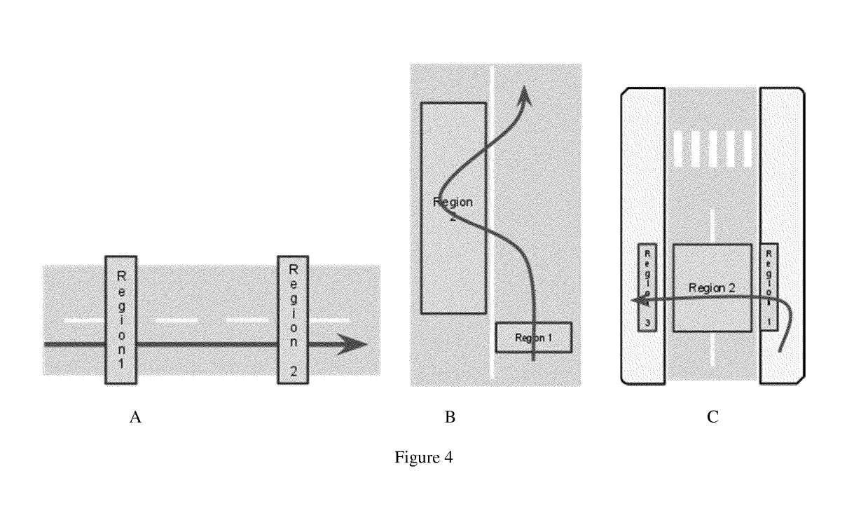

In another Example, the method and system is used to detect Red Light violations by adding a time element threshold to a region or its boundary. If a vehicle that passes through Region 1 passes through Region 2 within a specific time frame (when the traffic light was red) a red light violation has occurred (FIG. 4A). For Red Light violations the time frame is defined based on the traffic light cycle or by using digital image processing means to detect when the traffic light is red.

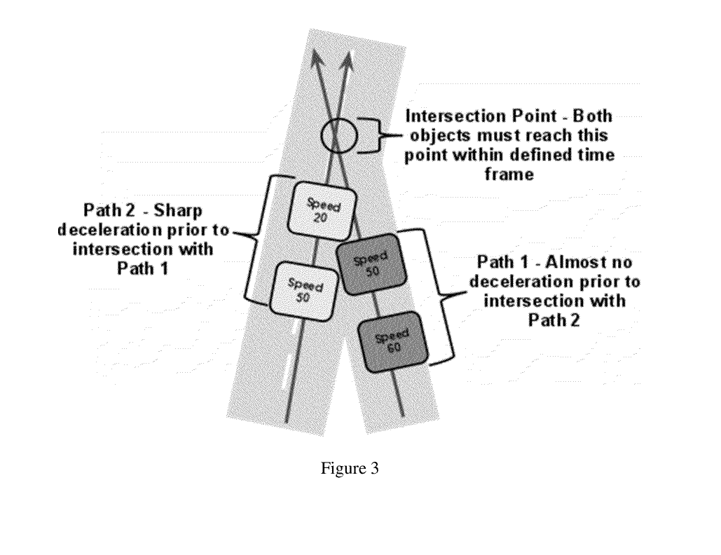

In yet another Example, shown schematically in FIG. 3, Right of Way violations are detected in one embodiment, in the following manner. Each blob contains the current speed and trajectory of the object. Speed is calculated by measuring the distance between a defined reference points on each blob on succeeding blobs in the path. Distance measuring is done in an embodiment by distance mapping pixels within the monitored area as described above. Distance mapping is done with minimal effort by using the distance mapping algorithm. All paths within a specific time slice are searched for intersection points. The intersections must have occurred within a defined time frame. As shown in FIG. 3, if Path A crossed Path B within 2 seconds of each other, a possible Right of Way violation might have occurred. If Path A crossed Path B within 10 seconds of each other no further checks are performed for the intersection point. For intersection points which have drawn intersect, the blobs are searched prior to the intersection point for sudden changes in acceleration.

If a sudden change in acceleration is found, a determination is made as to which path has Right of Way. A sudden deceleration for an acquired blob having a path determined to have Right of Way means that the vehicle was forced to quickly decelerate immediately prior to the intersection point. The vehicle had Right of Way and should not have had to decelerate. For Right of Way violations a threshold for deceleration is defined in one embodiment. Deceleration which is faster than the defined threshold would be declared a Right of Way of way violation (assuming the decelerating path had right of way).

In an embodiment, sudden or abrupt changes in acceleration or direction of a vehicle tracked using the methods and systems described herein, indicate a traffic violation, or anomalous driving behavior of the tracked vehicle, or in another embodiment of another moving vehicle that is not tracked by the systems and methods described or in yet another embodiment, of both moving objects. Sudden changes in velocity of a tracked vehicle will cause changes in that vehicle acceleration if positive or if negative (i.e. deceleration). In an embodiment, an acceleration threshold is defined as a positive change in acceleration of 2.20 m/s2, with 1.47 m/s2 considered as normal acceleration, and 2.94 m/s2 is specified as high acceleration (e.g. drag racing). In an embodiment, the threshold for deceleration is 3.5 m/s2 with 4 m/s2 defined as emergency breaking deceleration. Accordingly, acceleration or deceleration of a moving vehicle as described herein which exceeds the specified thresholds will be classified as sudden and indicate a possible violation of EITHER the tracked vehicle or another moving object in its vicinity or both. In an embodiment, the tracking and flagging of acceleration and deceleration and their impact on violation prediction is done in real time or as retrospective analysis on a video file as described herein. In an embodiment, In an embodiment, the tracking and flagging of acceleration and deceleration and their impact on violation prediction is done in the systems described herein, in the violation detection module.

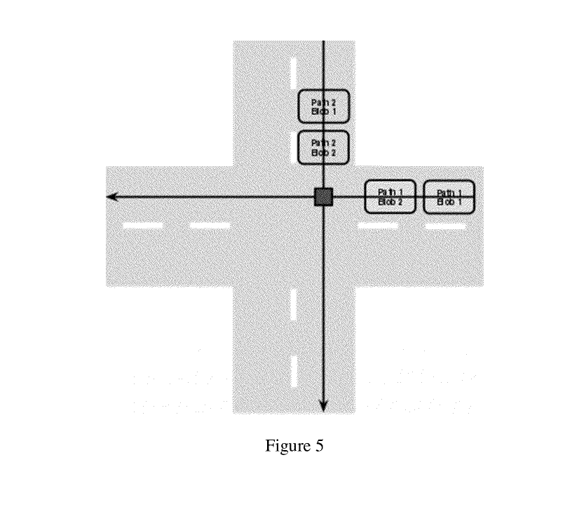

Turning now to FIG. 5, by drawing an edge between two predefined reference points on succeeding blobs in a path, a path's momentary direction (real-time trajectory is obtained. Edge intersection points for a given time slice represent in another embodiment, possible collision points between objects. A collision point poses a threat if the current trajectory of both objects is such that within a defined period of time both objects will reach the collision point (the same pixel or group of pixels) almost simultaneously. Object arrival at the intersection point is computed by using the object's current speed. Once a collision has been predicted, an alert can be launched by using a variety of methods such as flickering lights at the location in one embodiment, or alarm sounded on the same location, or electronic device located within or on the moving object, or as a command code capable of affecting the trajectory of one or both moving objects in other embodiments of the collision alarm produced by the methods and systems provided.

Turning now to FIG. 4: Speeding—Similar to the detection of Red Light violations, a Speed violation uses a time element (FIG. 4A). The time frame is set when the path enters Region 1. The time frame is assigned to Region 2. The time frame is current time+minimum allowed travel time between the two regions. Hence, if the path travels from Region1 to Region 2 before the time frame expires a speed violation has occurred. “Minimum allowed travel time between the two regions” is computed in one embodiment automatically, based on the permitted maximum speed and the distance between the two regions. Distance is figured automatically using the distance mapping algorithm. Another method of calculating the speed of an object is by dividing the real-world distance between two consecutive blobs in the same path in the time difference between them. Likewise White Line Crossing—Detecting a White Line Crossing violation is relatively trivial (FIG. 4B). No time elements or such need be defined. Also, in another Example; Jay Walking (FIG. 4C)—A jay walker can be detected by defining the sidewalk as Region 1, the road as Region 2 and the adjacent sidewalk as Region 3. Any object that leaves the sidewalk (Region 1) crosses the road (Region 2) and reaches the adjacent sidewalk (Region 2) subject to breaching of the thresholds including time and red light presence, is declared as a jaywalker.

In one embodiment, the methods and systems described herein are used in ports and control or provide alarm to forklifts. Accordingly, provided herein is a method of detecting a potential collision, the method comprising the steps of: obtaining a reference frame of a defined monitored area of a loading dock, or container loading area, or a warehouse; defining region boundaries within the loading dock, or container loading area, or a warehouse; based on a predetermined criteria, defining a plurality of thresholds within the defined area; using a video source, acquiring one or more forklift within the defined area; associating the acquired forklift with a previously acquired or a new trajectory; considering the plurality thresholds, detecting a potential collision wherein, if the acquired or new trajectory crosses the predetermined region boundaries or the trajectory of a second acquired forklift, in a specific sequence a a collision is about to occur; and providing an alarm.

It should be understood that in the methods and systems provided herein, the term “traffic violation” refers to any breach of a user define set of rules sought to be enforced in an area where moving objects interact with their environment and other moving objects. It is not to exclude pedestrians, boats, airplanes, animals, trains, their combination and the like.

While the invention is described through the above exemplary embodiments, it will be understood by those of ordinary skill in the art that modification to and variation of the illustrated embodiments may be made without departing from the inventive concepts herein disclosed. Therefore, while the preferred embodiments are described in connection with various illustrative data structures, one skilled in the art will recognize that the system may be embodied using a variety of specific data structures. In addition, while the embodiments may incorporate the use of video cameras, any appropriate device for capturing multiple images over time, such as a digital camera, may be employed. Thus the present system may be employed with any form of image capture and storage. Accordingly, the invention should not be viewed as limited except by the scope and spirit of the appended claims.

1. A method of detecting a traffic violation, the method comprising the steps of:
a. using a video source, obtaining a reference frame of a defined monitored area;
b. defining region boundaries within the monitored area;
c. optionally defining time span values for each region;
d. acquiring one or more moving objects within the defined area;
e. associating the acquired object with a previously acquired or a new trajectory;
f. Detecting a violation wherein, if the acquired or new trajectory crosses the predetermined region boundaries in a specific sequence and the trajectory crosses each region during the optionally defined time span a threshold has been violated and a traffic violation has occurred.

2. A method of predicting a collision between two or more moving objects, the method comprising the steps of:
a. using a video source, obtaining a reference frame of a defined monitored area;
b. based on a predetermined criteria, defining a plurality of parameters within the defined area such as at what distance from the predicted collision should affected parties be notified;
c. acquiring a plurality of moving objects within the defined area;
d. associating each acquired object with a previously acquired or a new trajectory in real time;
e. analyzing the acquired or new trajectories of the moving objects, whereby if two or more trajectories intersect and both objects will arrive at the intersection point within a predetermined time, a threshold has been violated and a collision is likely to occur.

3. A method for analyzing a traffic violation associated with failure to give a right of way within a predetermined area, or dangerous driving, the method comprising the steps of:
a. using a video source, obtaining a reference frame of a defined monitored area;
b. based on a predetermined criteria, defining a plurality of parameters within the defined area such as a plurality of regions where each region's precedence over all other regions is defined;
c. acquiring a plurality of moving objects within the defined area;
d. associating each acquired object with a previously acquired or a new trajectory in real time;
e. analyzing the acquired or new trajectories of the moving objects, whereby based on the predetermined parameters if two or more trajectories converge within a predetermined time, and one of the moving objects shows a sudden change in trajectory prior to the intersection point, and it can be determined based on region precedence that the object had precedence a threshold has been violated and a failure to give right of way has occurred.

4. The method of any one of claims 1-3 wherein the step of acquiring one or more moving objects comprises the steps of:
a. using the video source, obtaining a reference frame;
b. using the video source, obtaining subsequent frames;
c. comparing the change in pixel values between each frame and the reference frame; and
d. aggregating the pixels qualifying under the predetermined criteria to a blob, wherein each blob represents a single moving object.

5. The method of claim 4, comprising the step of assigning a trajectory to each blob.

6. The method of claim 1, wherein the step of obtaining a reference frame further comprises updating the reference frame every 1 minute to 12 hours.

7. The method of any one of claims 1-3, wherein the step of obtaining a reference frame further comprises assigning a value to each pixel in the reference frame.

8. The method of any one of claims 1-3, wherein the step of defining region boundaries within the monitored area comprises defining any form of geometric shape within the reference frame.

9. The method of claim 1, wherein the video source is a video camera, a MPG, MPEG, AVI, MOV, WMV, or ASF video file.

10. The method of any one of claims 2, 3 and 9, further comprising the step of saving an analysis data of the violation.

11. The method of claim 10, further comprising storing the analysis data on a computer readable media.

12. The method of claim 10, further comprising the step of transmitting the analysis data to a remote server.

13. A system for monitoring, determining and reporting a traffic violation, the system comprising:
a. a digital video source;
b. an integral processor, the integral processor operably connected to the video source and capable of:
i. acquiring at least one object within a predetermined defined area obtained from the video source;
ii. identifying motion of the acquired object
iii. assigning the acquired object to a trajectory
iv. detecting a violation based on predefined thresholds
v. creating and saving analysis data; and
c. a transmitter, capable of transmitting the analysis data to a remote user.

14. The system of claim 13, wherein the digital video source is a camera or a video file.

15. The system of claim 14, wherein the video file is in MPG, MPEG, AVI, MOV, WMV, or ASF format.

16. The system of claim 14, further comprising a memory, a screen or their combination operably connected to a computer.

17. The system of claim 14, wherein the transmitter is a MIMO transmitter having a RF terminal, a WWAN terminal, a WLAN terminal or a combination thereof.

18. The system of claim 14, wherein the remote user accesses the data via internet.

19. The system of claim 18, wherein the analysis data is transmitted via internet to a moving vehicle acquired by the system in the form of a collision warning.

20. The system of claim 19, wherein the collision is between the moving vehicle and another moving vehicle.

21. The system of claim 19, wherein the collision is between the moving vehicle and a stationary object.
